(19) United States
(12) Patent Application Publication
(10) Pub. No.: US 2024/0086731 A1
(43) Pub. Date: Mar. 14, 2024

(54) KNOWLEDGE-GRAPH EXTRAPOLATING METHOD AND SYSTEM BASED ON MULTI-LAYER PERCEPTION

(71) Applicant: Huazhong University of Science and Technology, Wuhan City (CN)

(72) Inventors: Feng ZHAO, Wuhan City (CN); Mingtao CHEN, Wuhan City (CN); Kangzheng LIU, Wuhan City (CN); Hai JIN, Wuhan City (GB)

(21) Appl. No.: 18/154,637

(22) Filed: Jan. 13, 2023

(30) Foreign Application Priority Data
Sep. 6, 2022 (CN) CN202211088984.4

(51) Int. Cl. G06N 5/022

(52) U.S. Cl. CPC G06N 5/022

(57) ABSTRACT

The present invention relates to a knowledge-graph extrapolating method and system based on multi-layer perception, the method comprising: using relational graph convolutional network encoders to learn embedding representations, and capturing dynamic evolution of a fact; designing emerging task processing units to construct multiple layers of entity sets, and assigning a matching historical relevance; classifying prediction tasks into different reasoning scenes, and connecting them to the corresponding processing unit for partition of entity sets; and using a multi-class task solving method to acquire predicted probability distributions of target entities, and taking the highest one as a prediction answer, so as to accomplish extrapolation of a temporal knowledge graph, wherein the prediction tasks are classified into different reasoning scenes according to whether it contains any entity or relation that has never appeared historically. The knowledge-graph extrapolating system comprises a processor that can run program code information of the disclosed method.

### BACKGROUND OF THE INVENTION

### 1. Technical Field

The present invention relates to the technical field of temporal knowledge-graph reasoning, and more particularly to a knowledge-graph extrapolating method and system based on multi-layer perception.

### 2. Description of Related Art

A knowledge graph is a series of various patterns showing evolutional progress and structural relations of knowledge. Based on visualization, knowledge graph describes knowledge resources and their carriers, and enables mining, analysis, construction, and display knowledge and relations of knowledge. By combining theories and methods of subjects like applied mathematics, graphics, information visualization, information science with methods like metrological citation analysis and co-occurrence analysis, a knowledge graph uses a visualized images to graphically exhibit core structures, development history, frontier fields, and overall knowledge structures of disciplines, so as to achieve multidisciplinary cross connection.

A temporal knowledge graph (TKG) is a new form for showing a series of temporal facts (or knowledge entries) in the real world, and is usually stored as quadruplets, namely (subject entity, predicate relation, object entity, timestamp), or shorted as (s, r, o, t). A TKG conveys rich semantic information such as concepts, attributes, and relations, and allows language understanding by machines to be extensively used in basic natural language processing tasks, such as commonsense knowledge extraction and reading comprehension. In addition, TKG-enabled knowledge guide and make artificial intelligence explainable, facilitate implementation of recommendation systems and smart conversation systems, among others.

Essentially, temporal knowledge graph reasoning is about predicting new facts from existing temporal facts, which means knowledge completion or link prediction. Assuming that a quadruplet (s, r, o, [t₀, t₁]) exists in a timestamp interval from t₀ to t₁, temporal knowledge graph reasoning can be interpolation or extrapolation. The difference between the two modes mainly relies on that a known fact in the interpolation setting may have a timestamp later than t₁, yet all known facts in the extrapolation setting have their timestamps earlier than t₁. While most of the existing reasoning models are focused on interpolation, some extrapolation models have received increasing attention recently, such as models using temporal embeddings, temporal hyperplanes, and additive time-series decomposition to encode temporal information; models capturing rich interaction information between time and multi-relation features by pivoting facts; and models using message passing networks to capture neighborhood information in graph snapshots.

CN114780739A discloses a time sequence knowledge graph completion method and system based on a time graph convolution network. The time sequence graph convolution network comprises a structure encoder, a time sequence encoder and a decoder. The method includes firstly, selecting a time sequence knowledge graph G to be complemented, and determining a target time step of the time sequence knowledge graph to be complemented; then generating entity embedded vectors and relation embedded vectors of each time step of the time sequence knowledge graph through a structure encoder; then generating a final embedded vector corresponding to the entity and the relation at the prediction time step through a time sequence encoder; and finally, predicting missing contents in the time sequence knowledge graph to be complemented according to the obtained final embedded vector corresponding to the head entity s, the relation r and the tail entity o in the time step t from a candidate quadruplet (s, r, o, t) through a decoder, and completing complementation of the time sequence knowledge graph. The method is purported to effectively improve the accuracy of the completion task of the time sequence knowledge graph.

CN112860918A discloses a sequential knowledge graph representation learning method based on a collaborative evolution modeling. It belongs to the technical field of sequential knowledge graphs, and initializes the parameters of a model and the embedded representation of any entity and relationship according to the sequential knowledge graph to be represented; calculating to obtain the occurrence probability of each known fact, and obtaining the evolution loss of the local structure by maximizing the occurrence probability of the known facts; calculating the corresponding soft modularity for the graph structure of each time sequence knowledge graph snapshot, and maximizing the soft modularity to obtain the evolution loss of the global structure; calculating to obtain an integral loss function of the model; and iteratively optimizing the overall loss function of the model by using a gradient descent method until the model converges. The invention solves the problem that the accurate embedded representation cannot be obtained because the evolution essence of the time sequence knowledge graph is ignored in the past work.

However, as being extensively used in more fields, temporal knowledge graphs are usually found to be incomplete and constricted by the closed world assumption and the assumption of existing facts, leading to limited development of TKG applications in terms of both breadth and depth and degraded accuracy and interpretability of many reasoning applications. Specifically, the advantages of the existing models include: (1) incapability of predicting events with future timestamps in order if they are not informed of facts of prior events in a certain timestamp range; (2) low efficiency because the historical records for each search have to be encoded separately; and (3) significantly reduced reasoning accuracy due to failure in considering never-appeared entities and relations in prediction tasks.

Since there is certainly discrepancy between the prior art comprehended by the applicant of this patent application and that known by the patent examiners and since there are many details and disclosures disclosed in literatures and patent documents that have been referred by the applicant during creation of the present invention not exhaustively recited here, it is to be noted that the present invention shall actually include technical features of all of these prior-art works, and the applicant reserves the right to supplement the application with the related art more existing technical features as support according to relevant regulations.

### SUMMARY OF THE INVENTION

In view of the shortcomings of the prior art, the present invention provides a knowledge-graph extrapolating method based on multi-layer perception and a system thereof, particularly a computing model that performs multi-layer path mining around historical events so as to flexibly process prediction tasks including any entity or relation that has never seen historically, to at least address the technical issues of the prior art.

Preferably, opposite to some existing models that reasoning poorly and provide inaccurate predictions due to failure in considering that prediction tasks may involve information that has been never seen historically, and other existing models that bias to never-appeared entities and cause deficient topological structures of reasoning scenes, the present invention, in view of incompleteness of temporal knowledge graphs, proposes a knowledge-graph extrapolating method based on temporal multi-layer perception, which predicts future potential events based on historical facts, and facilitates discovery of tacit knowledge, thus being more practical than static methods and dynamic interpolation methods.

The present invention provides a novel knowledge graph extrapolation model TMP-Net that is based on multi-layer perception, which, for every snapshot, continuously learns representation of entities, relations, and timestamps, thereby being capable of capturing long-term dependency, allowing the model to be more capable of semantic representation. Further, the present invention can divide existing entity sets according to their historical relevance levels, so as to provide entity sets of four different layers of relevance for prediction tasks, and can make prediction more accurately through combination of reviewing known mechanisms and envisioning unknown mechanisms. What makes the present invention special is that entities and relations are considered separately, making it possible to flexibly process four different classes of reasoning scenes including an entity or a relation that have never appeared historically. Additionally, with the specially designed emerging task processing units, the present invention can perform mining for entity sets at four layers of the four classes of reasoning scenes. Furthermore, the present invention adopts a multi-class task solving method to acquire predicted probability distributions of target entities and provide interpretable reasoning results.

The present invention discloses a knowledge-graph extrapolating method based on multi-layer perception, the method comprising:
using relational graph convolutional network encoders to learn embedding representations of entities, relations and timestamps, and capturing dynamic evolution of a fact;
designing emerging task processing units to construct multiple layers of entity sets, and assigning a matching historical relevance degree to the entity sets at each of the multiple layers;
classifying prediction tasks into different classes of reasoning scenes, and connecting each of the classes of the reasoning scenes to the processing unit for the corresponding layer, so as to accomplish partition of the multiple layers of the historically relevant entity sets; and
using a multi-class task solving method to acquire predicted probability distributions of target entities, and taking the entity having a highest level of probability as a prediction answer, so as to accomplish extrapolation of a temporal knowledge graph,
wherein the prediction tasks are classified into different classes of reasoning scenes according to whether it contains any entity or any relation that has never appeared historically.

According to a preferred embodiment, the emerging task processing units search in the current fact for entities related to the prediction tasks and group the searched entities as entity sets of first, second, and third layers, and, by comparing all the entity sets of a data set, identify and group the entities that have never appeared into entity sets of a fourth layer, wherein at the first layer are the entity sets directly connected to relation predicates of the prediction tasks, at the second layer are the entity sets that can be reached by subject entities of the prediction tasks in one hop or two hops, at the third layer are the entity sets that can be reached through remaining paths in the current fact in multiple hops, and at the fourth layer are the entity sets that have never appeared historically.

According to a preferred embodiment, the historical relevance degrees assigned to the entity sets at the four layers are represented by scalars from inside to outside as α, β, γ and δ, wherein α>β>γ>δ, and α+β+γ+δ=1.

According to a preferred embodiment, the prediction tasks are at least classified into at least the four classes of reasoning scenes: Class 1 having neither never-appeared entities nor never-appeared relations, Class 2 having only never-appeared entities, Class 3 having only never-appeared relations, and Class 4 having both never-appeared entities and never-appeared relations.

According to a preferred embodiment, the different prediction tasks are processed using the different number of layers for the multi-layer path extrapolation, and each of the classes of the reasoning scenes is connected to a processing unit for the corresponding layer, wherein the number of layers for the multi-layer path extrapolation corresponds to the entity sets at the multiple layers.

According to a preferred embodiment, the method further comprises: mapping each of the entities, relations and timestamps data of the data set into a low-dimension dense vector space, initializing all pre-determined parameters through Xavier initialization, and then using Cross-Entropy Loss Function to minimize global loss thereby optimizing parameter learning.

According to a preferred embodiment, a w-layer relational graph convolutional network encoder is used for representation learning to converge and extract features of the different relations, wherein the w-layer relational graph convolutional network encoder is represented as:

$${h}_{s , {t}_{T}}^{( l + 1 )} = σ ( {\sum }_{( r , o ) \vert ( s , r , o , {t}_{T} ) ∈} \frac{1}{N} {W}_{r}^{( l )} {h}_{o , {t}_{T}}^{( l )} + {W}_{loop}^{( l )} {h}_{s , {t}_{T}}^{( l )} ) ,$$

where h_{o,t}_{_{T}}^{(l)} and T_{s,t}_{_{T}}^{(l)} are embeddings of the entities s and o in a graph snapshot [symbol] _{T} at the l^{th} layer with a timestamp t_{T}, respectively, and Wᵣ^{(l)} and Wₗₒₒₚ^{(l)} are weight matrixes for converging the features from the different relations and a self-loop matrix for the l^{th} layer.

According to a preferred embodiment, the multi-class task solving method uses a multilayer perceptron and a SoftMax logistic regression model to convert the prediction tasks into entity multi-class tasks, wherein each of the classes corresponds to the level of probability of one of the target entities, so that the entity having the highest level of probability is taken as the prediction answer.

According to a preferred embodiment, a final prediction Oₜ_{_{q}} is the entity having a highest level of combined probability, defined as:

oₜ_{_{q}}=argmax_{o∈ε}p(o|s,r,t_{q}).

The present invention discloses a knowledge-graph extrapolating system based on multi-layer perception, the system comprising at least one processor configured to:
use relational graph convolutional network encoders to learn embedding representations of entities, relations and timestamps, and capture dynamic evolution of a fact;
design emerging task processing units to construct multiple layers of entity sets, and assign a matching historical relevance degree to the entity sets at each of the multiple layers;
classify prediction tasks into different classes of reasoning scenes, and connecting each of the classes of the reasoning scenes to the processing unit for the corresponding layer, so as to accomplish partition of the multiple layers of the historically relevant entity sets; and
use a multi-class task solving method to acquire predicted probability distributions of target entities, and take the entity having a highest level of probability as a prediction answer, so as to accomplish extrapolation of a temporal knowledge graph,
wherein the prediction tasks are classified into different classes of reasoning scenes according to whether it contains any entity or any relation that has never appeared historically.

Preferably, the emerging task processing units are in the processor.

Preferably, the disclosed knowledge-graph extrapolating method based on temporal multi-layer perception gives consideration to entities and relations that have never appeared historically and accordingly designs emerging task processing units and four different classes of reasoning scenes (neither never-appeared entities nor never-appeared relations, only containing never-appeared entities, only containing never-appeared relation, and containing both never-appeared entities and relations). To address the challenges for reasoning scenes 1, 2, 3, this method innovatively makes separate consideration for entities and for relations, and performs path mining in known facts based on historical relevance, so as to acquire entity sets directly connected to relations (related to the first layer) and entity sets that can reach relations in two or more hops (related to the second and third layers). For reasoning of scenes 4, this method acquires entity sets that have never occurred in the past (related to the fourth layer). At last, together with the four-layer reasoning mode, a multi-class task solving method is used to acquire the predicted probability distribution, thereby accomplishing fact reasoning.

### BRIEF DESCRIPTION OF THE DRAWINGS

FIG. 1 is a structural diagram of a TMP-Net model according to a preferred embodiment of the present invention; and

FIG. 2 is a flowchart of modeling for emerging task processing units according to a preferred embodiment of the present invention.

### DETAILED DESCRIPTION OF THE INVENTION

The present invention will be detailed with reference to the accompanying drawings.

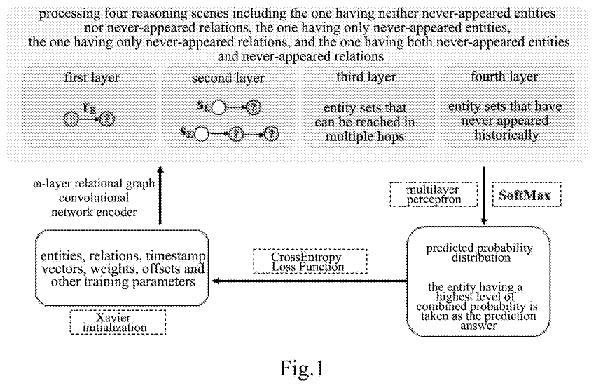

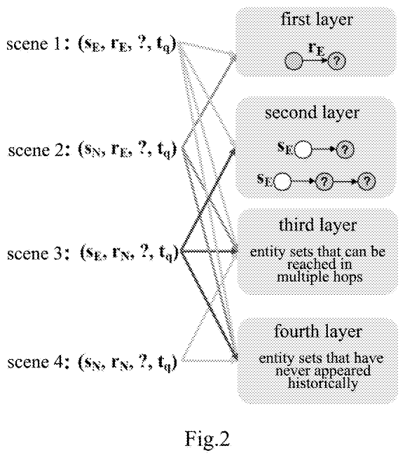

FIG. 1 is a structural diagram of a TMP-Net model according to a preferred embodiment of the present invention, and FIG. 2 is a flowchart of modeling for emerging task processing units according to a preferred embodiment of the present invention.

The present invention provides a knowledge-graph extrapolating method based on multi-layer perception. The present invention may further provide a knowledge graph extrapolating system based on multi-layer perception. The knowledge graph extrapolating system may be an apparatus using the knowledge-graph extrapolating method or an electronic device having knowledge graph extrapolating functions. Preferably, the knowledge graph extrapolating system may comprise emerging task processing units.

The present invention may further provide a storage medium. The storage medium stores the program code information of the knowledge-graph extrapolating method of the present invention.

The present invention may further provide a processor. The processor runs program code information of the knowledge-graph extrapolating method of the present invention. Preferably, the emerging task processing units may be configured in the processor.

Preferably, a knowledge graph refers to a directed graph composed of a large number of nodes and edges, wherein the nodes represent the entity concept in the real world and the edges represent various relations between connected entities. Therein, every knowledge entry is generally in the form of a triplet, describing the relation between its head entity and its tail entity.

Further, a temporal knowledge graph (TKG) is a new form for showing a series of temporal facts (or knowledge entries) in the real world, and is usually stored as quadruplets, namely (subject entity, predicate relation, object entity, timestamp), or shorted as (s, r, o, t).

Preferably, multi-layer perception is an experimental method adopted by the present invention. The method involves multi-layer path mining, wherein every layer has a corresponding way to acquire entity sets.

Preferably, a sub-graph means a sub-graph of a temporal knowledge graph at a certain timestamp. A temporal knowledge graph is composed of quadruplets, and all quadruplets, after sorted by timestamp in an ascending order, can be naturally divided into different sub-graphs each having a different timestamp.

Preferably, the convolutional network encoder is a relational graph convolutional network encoder. Therein, the relational graph convolutional network, or R-GCN, is a deep learning neural network model, which facilitates implementation of link prediction tasks. An R-GCN is an encoding-decoding model, and it principally operates as: first using an encoder to transform all entities and relations into vectors through representation learning, and then using a decoder (generally a score function) to obtain the predicted probability distribution of each entity. Specifically, in the present invention, only the encoder in the relational graph convolutional network is used to obtain vector representations of entities, relations, and timestamps, and then a multi-layer perceptron and Softmax are used to accomplish multi-class tasks.

Preferably, Xavier initialization is a variable initialization method for dealing with random initialization. Its central concept is to make the input and the output follow the same distribution as much as possible, so as to prevent the output value of the activation function of the subsequent layer from drifting towards 0. Specific to the present invention, vanishing gradient (when the gradient is very close to 0) and exploding gradient (when the gradient is extremely large) tend to happen during network training and make most gradients obtained through backpropagation ineffective or even counterproductive (backpropagation is mainly achieved using Cross-Entropy Loss Function and Adam Optimizer in the present invention). Therefore, it is of great importance to reasonably initialize all vectors and variables used in training. Known for its good performance, Xavier initialization is used in the present invention for initialization of training parameters such as entities, relations, timestamp vectors, weights, and offsets.

Preferably, Cross-Entropy Loss Function is a loss function commonly used for classification in deep learning. Specifically, the present invention uses this function to obtain the loss from the predicted result to the correct result after each round of training, and uses Adam Optimizer to perform gradient descent backpropagation to update all variables for training in a real-time manner, so as to make prediction in the next round of training more accurate.

Preferably, a multilayer perceptron, also known as an MLP, is a simple and authentic neural network model, often used in implementing multi-class tasks. Generally, a multilayer perceptron has three layers, including an input layer, a hidden layer, and an output layer, all connected, which means that any neuron in the previous layer is connected to all neurons in the next layer. Its implementation includes three elements, namely the weight, the bias, and the activation function, corresponding to Wₘₗₚ, bₘₗₚ, and tanh in the equations recited herein. Specific to the present invention, the multilayer perceptron receives the vectors of the four classes of entity sets obtained by the relational graph convolutional network encoder through training in multi-layer perception, and an activation function is used after the hidden layer, so as to limit the output of each entity at the multilayer perceptron in the numeral range of (−1, 1).

Preferably, logistic regression algorithms are machine learning algorithms extensively used in various fields. As a logistic regression algorithm, Softmax is usually used in multi-class task models, and serves to convert multi-class output values into probability distributions that range within [0, 1] and have a sum of 1. Specifically, the present invention uses Softmax to receive the output of each entity during prediction from the multilayer perceptron and transforms the output into the predicted probability of the entity. Therein, the largest one (max) is the candidate entity.

Preferably, the purpose of deep learning is to provide various nonlinear transformation fitting outputs from an input by continuously changing network parameters, and this essentially is a process where a function finds the optimal solution. Therefore, updating of parameters is the center of research of deep learning. Since algorithms used to update parameters are usually referred to as optimizers, the task of the foregoing process can be literally explained as determining which algorithm is to be used for optimizing parameters of a network model. The most used optimizer is gradient descent, and Adam Optimizer is a first-order optimization algorithm as an alternative of the traditional random gradient descent process. Adam serves to iteratively update a weight of a neural network based on training data. Specifically, the present invention uses Adam Optimizer to iteratively update and optimize parameters involved throughout training of the model, so as to obtain more accurate prediction results.

Preferably, as defined in the present invention, the prediction timestamp is a future timestamp, and any timestamp before this is at a past time point and associated to a fact that has historically happened. Hence, existing entities are entities included in history quadruplets, and never-appeared entities are entities that have never occurred in the past. Similarly, existing relations are relation predicates included in history quadruplets, and never-appeared relations are relations that have never occurred in the past.

According to a preferred embodiment, the disclosed knowledge-graph extrapolating method based on multi-layer perception comprises the following steps.

At S1, a temporal knowledge graph is divided into sub-graphs [symbol] ={ [symbol] ₁, [symbol] ₂, . . . , [symbol] ₜ, . . . } by timestamp, and relational graph convolutional network encoders are used to learn embedding representations of entities, relations, and timestamps and capture dynamic evolution of a fact.

Specifically, Xavier initialization is used for initialization of all training parameters. For every snapshot, training sessions are set for continuous learning representation so that dynamic evolution of the fact can be captured.

S2 involves designing emerging task processing units to construct multiple layers of entity sets, and assigning a matching historical relevance degree to the entity sets at each of the multiple layers;

Specifically, the emerging task processing units search in the current fact for entities related to the prediction tasks and group the searched entities as entity sets of first, second, and third layers, and, by comparing all the entity sets of a data set, identify and group the entities that have never appeared into entity sets of a fourth layer. Then, for the entity sets of the foregoing four layers, corresponding historical relevance degrees are assigned.

S3 is about classifying prediction tasks into four classes of reasoning scenes, and connecting each of the classes of the reasoning scenes to the processing unit for the corresponding layer, so as to accomplish partition of the four layers of the historically relevant entity sets.

Specifically, the prediction tasks are classified into four classes of reasoning scenes whether it contains any entity or any relation that has never appeared historically.

S4 involves using a multi-class task solving method to acquire predicted probability distributions of target entities, and taking the entity having a highest level of probability as a prediction answer.

Specifically, together with vector representations of the four layers of entity sets in the first part, a multilayer perceptron is used and a Softmax logistic regression model is introduced to acquire the predicted probability distribution of the target entity. At last, the entity having a highest level of probability is taken as the prediction answer, so as to complete extrapolation of the temporal knowledge graph.

Preferably, at S1, the temporal knowledge graph is formed by arranging timestamps in an ascending order. Preferably, “using relational graph convolutional network encoders to learn embedding representations of entities, relations, and timestamps” as conducted at S1 mainly provides the following features:
(1) mapping each of the entities, relations, and timestamps data of the data set into a low-dimension dense vector space, initializing all pre-determined parameters through Xavier initialization, and then using Cross-Entropy Loss Function to minimize global loss thereby optimizing parameter learning; and
(2) using a ω-layer relational graph convolutional network encoder to perform representation learning to converge and extract features of the different relations, so as to make entity pairs having relations on each timestamp have certain relevance degrees.

Further, in the training process of the TMP-Net model with respect to different vectors and parameters shown in the structural diagram of FIG. 1, entities, relations, timestamp vectors, weights, offsets, and other training parameters are used as input to be mapped into a low-dimensional continuous vector space. Then with Xavier initialization, a tool commonly used for initialization in deep learning, the relational graph convolutional network can learn more useful semantic information during training. Therein, the ω-layer relational graph convolutional network encoder is represented as:

$${h}_{s , {t}_{T}}^{( l + 1 )} = σ ( {\sum }_{( r , o ) \vert ( s , r , o , {t}_{T} ) ∈ {T}_{}} \frac{1}{N} {W}_{r}^{( l )} {h}_{o , {t}_{T}}^{( l )} + {W}_{loop}^{( l )} {h}_{s , {t}_{T}}^{( l )} ) ,$$

where h_{o,t}_{_{T}}^{(l)} and h_{s,t}_{_{T}}(l) are embeddings of the entities s and o in a graph snapshot [symbol] _{T} at the l^{th} layer with a timestamp t_{T}, respectively, and Wᵣ^{(l)} and Wₗₒₒₚ^{(l)} are weight matrixes for converging the features from the different relations and a self-loop matrix for the l^{th} layer.

In order to optimize parameter learning, the TMP-Net uses a multi-component cross entropy function:

[symbol]

=−Σₜ₌ₜ_{₁}^{t}ₜᵣₐᵢₙΣ_{(s,r,o}_{ₜᵣᵤₜₕ},t)∈ [symbol] ₜΣ_{i∈ε}_{ₜ}oₜᵣᵤₜₕlnp(oᵢ|s,r,t),

where εₜ is the entity sets of the snapshot [symbol] _{T}, p(oᵢ|s, r, t) is the combined probability value of the i^{th} object entity when the query is (s, r, ?, t_{q}) and the real object entity is oₜᵣᵤₜₕ, with the Adam optimizer used for training of loss.

Preferably, at S2, the emerging task processing units search for entities historically related to the prediction task from the current fact and take them as entity sets at the first, second, and third layers, and, by comparing all the entity sets of a data set, identify and group the entities that have never appeared into entity sets of a fourth layer.

In an example where prediction for an object (s, r, ?, t_{q}) is to be made, the learning process of the emerging task processing unit comprises the following steps:
(1) taking entity sets (Σₜ₌ₜ_{₁}^{t}^{_{q−1}}Xₜ) directly connected to all relations with the prediction task in the current fact as the first layer of multi-layer path extrapolation;
(2) searching for entity sets (Σₜ₌ₜ_{₁}^{t}^{_{q−1}}Yₜ) from the current fact that can reach the subject entity of the prediction task in one or two hops, and composing them into the second layer of multi-layer path extrapolation;
(3) composing entity sets (Σₜ₌ₜ_{₁}^{t}^{_{q−1}}Zₜ) in the remaining paths of the current fact that can be reached in more than two hops into the third layer of multi-layer path extrapolation so as to break the limitation of two-hop path search;
(4) determining, based on the possibility that there is any target predicate never seen historically, and performing analysis of variance by comparing all entity sets, so as to acquire a fourth layer of multi-layer path extrapolation composed of entity sub-sets (Σₜ₌ₜ_{₁}^{t}^{_{q−1}}Uₜ) that have never appeared in the past; and
(5) subsequently, assigning historical relevance degrees to entity sets of the first, second, third, and fourth layers, wherein the historical relevance degrees are quantified as α, β, γ, and δ layer by layer from inside to outside, so as to achieve interaction throughout the training and reasoning stages.

Further, in an example where prediction for the object (s, r, ?, t_{q}) is performed, at the first layer are the entity sets directly connected to the relation predicate of the prediction task, at the second layer are the entity sets that can be reached by subject entities of the prediction task in one hop or two hops, at the third layer are the entity sets that can be reached through remaining paths in the current fact in multiple hops, and at the fourth layer are the entity sets that have never appeared historically, thereby eliminating the interference that may happen if the target predicate is an entity that has never appeared historically. They are represented as Σₜ₌ₜ_{₁}^{t}^{_{q−1}}Xₜ, Σₜ₌ₜ_{₁}^{t}^{_{q−1}}Yₜ, Σₜ₌ₜ_{₁}^{t}^{_{q−1}}Zₜ, Σₜ₌ₜ_{₁}^{t}^{_{q−1}}Uₜ, respectively, where X, Y, Z and U are all N-dimensional multi-hot indicator vectors, and N is the total scalar of the data set entities. The specific flowchart of implementation is as shown in FIG. 2.

Preferably, the historical relevance degrees assigned to the four layers of entity sets are represented by scalars from inside to outside as α, β, γ, and δ, where α>β>γ>δ, and α+β+γ+δ=1.

Further, the history table acquired by the TMP-Net may be represented as:

c(s,r)=αΣₜ₌ₜ_{₁}^{t}^{_{q−1}}Xₜ+βΣₜ₌ₜ_{₁}^{t}^{_{q−1}}Yₜ+γΣₜ₌ₜ_{₁}^{t}^{_{q−1}}Zₜ+δΣₜ₌ₜ_{₁}^{t}^{_{q−1}}Uₜ.

Preferably, if an entity appears in X, Y and Z, the predicted probability of the entity accumulated correspondingly, and the maximum scalar and the minimum scalar of the entities in c^{(s,r)} are 1 and 0, respectively.

Preferably, at S3, the TMP-Net can, according to whether s and r are s_{N} and r_{N}, respectively, divide the prediction tasks into the following four classes of reasoning scenes: scene 1: (s_{E}, r_{E}, ?, t_{q}), scene 2: (s_{N}, r_{E}, ?, t_{q}), scene 3: (s_{E}, r_{N}, ?, t_{q}), and scene 4: (s_{N}, r_{N}, ?, t_{q}), where s_{E} and s_{N} represent the existing and never-appeared subject entities, respectively, and r_{E} and r_{N} represent the existing and never-appeared relation predicates, respectively. Therefore, it is first to recognize the class of the prediction task, and then the emerging task processing units obtain entity sets with different historical relevance degrees related to the query following the process shown in FIG. 2.

Further, prediction tasks are processed specifically with the corresponding number of the layers for multi-layer path extrapolation, and each of the classes of the reasoning scenes is connected to the processing unit for the corresponding layer, so as to accomplish partition of the four layers of the historically relevant entity sets.

Specifically, scenes 1 pass the first, second, third, and fourth layers of the multi-layer perception, scenes 2 pass the first, third, and fourth layers of the multi-layer perception, scenes 3 pass the second, third, and fourth layers of the multi-layer perception, and scenes 4 pass the third, and fourth layers of the multi-layer perception.

Further, an entity more relevant to the query has the greater predicted probability.

Preferably, at S4, a multilayer perceptron and a Softmax logistic regression model transform a prediction task into an entity multi-class task. Therein, every class corresponds to the probability of one target entity, thereby naturally taking the entity having a highest level of probability as a prediction answer, and accomplishing the knowledge graph prediction task.

Further, the TMP-Net dedicated to predict events that have not happened yet rather than current facts may first use a multilayer perceptron to train an index vector Vₒ; and

then increase the estimated probability of the entity that is most relevant to the given search by adding c^{(s,r)} to Vₒ:

\dot{v}ₒ=tanh(Wₘₗₚ[Sₜ_{_{q}},Rₜ_{_{q}},Tₜ_{_{q}}]+bₘₗₚ)+c^{(s,r)},

where Wₘₗₚ∈ [symbol] ^{3d×N} and bₘₗₚ∈ [symbol] ^{N} are both training parameters, and tanh is a nonlinear activation function.

At last, the function Softmax is used to estimate the probability of the target predicate entity in the current fact: p(r)=softmax(\dot{v}ₒ),

where p(r) is an N-dimensional vector, including reasoning probability of all entities, and the greatest dimension in the final p(r) represents the target object entity.

Preferably, the final prediction Oₜ_{_{q}} will be the entity having the highest combined probability, defined as:

oₜ_{_{q}}=argmax_{o∈ε}p(o|s,r,t_{q}),
where p(o|s, r, t_{q}) is another form of representation of p(r) representing the probability distribution of the prediction in the current fact.

Preferably, in order to close the loop of the tested training, in the training process, the function Cross-Entropy Loss as mentioned in the first part is used for updating of the tensors and the parameters, so as to appropriately adjust the prediction result.

Exemplarily, the server usable in disclosed knowledge-graph extrapolating method may be a commercially available product modeled Dell R740, which has a CPU of Intel(R) Xeon(R) Gold 6132 @2.60 GHz and a GPU of Tesla M40, with memory capacity of 128 GB DDR4 RAM and storage capacity of 1 TB SSD+4 TB HDD.

Preferably, the disclosed knowledge-graph extrapolating method or the server using the knowledge-graph extrapolating method may be used in an integrated technology service platform, which provides users with recommendation (reasoning) services about technical data. For example, they may be used in of CNKI (China National Knowledge Infrastructure), the database of Chinese Journal of Science and Technology (of Chongqing VIP Co., China), and the China Dissertations Database (Wanfang Data, China) for recommendation (reasoning) services about technical data such as theses, patents, and projects.

Specifically, when a user searches data in an integrated technology service platform, the present invention can recommend technical data of the relevant field based on the temporal knowledge graph according to search history of the user and bookmarks or favorites set previously by the user, automatically. Herein, in searches for thesis data, vertices represent key attributes, such as conference/journal and year in which the thesis was published, or the author, title, and the total number of pages of the thesis, and are the visualized nodes of the temporal knowledge graph; and edges represent dependency between vertices, and may be detailed to some certain attribute relation, such as expressing that the conference/journal was held by XXXX organization, the author served in XXXX, or the thesis was published in the year XXXX, and are the visualized edges of the temporal knowledge graph. Since entities may evolve over time, the dependency records the effective period (or the lifetime) of this attribute relation. For example, as to a thesis, the effective period of all related information begins from the moment on which the thesis was employed, and the lifetime is permanent because an employed thesis will never be retracted unless in the event of major academic dishonesty. As another example, a life information entry of someone (such as Isaac Newton, born on Jan. 4, 1643 and dead on Mar. 31, 1727) is untrusted or recognized unless its timestamp falls within the corresponding time period ([1643.1.3, 1727.3.31]).

Preferably, the data processed by the processor may be structured relation data, such as texts (.txt) and tables (.xls\.xlsx\.csv\.sql), or may be graphic data from graph databases like Neo4j. At the back end of the server, KGQL data processing units are constructed (mainly by means of Java programming language), which allow inter-system communication by calling the API interface of the platform, thereby collecting the foregoing data interactively. Therein, the protocol used in the application layer network is HTTPS (i.e., a security-focused HTTP channel system), which is superior to HTTP in terms of data security. Based on this, KGQL extracts knowledge from the data collected through the interface to form knowledge entries in the form of quadruplets, which are delivered to the processor in the server for subsequent processing.

Preferably, the server passes the processed data to a storage system composed of an array of disks, such as SSDs or HDDs, so that the data can be stored by a database management system such as MYSQL or Neo4j, where the data are reconstructed and managed. On this basis, data support can be provided to subsequent applications, so as to achieve knowledge representation learning, multi-purpose data retrieval services, multi-dimensional data analysis, statistical services, and high-accuracy data reasoning, recommendation services, and eventually applications in transformation of scientific and technological achievements and application demonstration of integrated technology service platforms, so as to provide comprehensive technology services to governmental agencies or private businesses.

Preferably, the processed data are stored in the database in the form of temporal knowledge graphs. Then the data can be transmitted, through the interface of the database, to a knowledge representation learning module, where vector representations of entities, relations, and timestamps can be acquired fast by a GPU. Alternatively, the data can be transmitted, through the interface of the database, to a multi-layer path mining module, where entity sets of different historical relevance degrees can be acquired. Alternatively, the data can be transmitted, through the interface of the database, to a knowledge reasoning module, where the data can be searched for provision of data recommendation services at an integrated technology service platform through API interface.

According to a specific embodiment, the disclosed knowledge-graph extrapolating system comprises an R-GCN encoder, an emerging task processing unit and temporal reasoning task prediction section (including reasoning scene classification and multi-class task processing). Preferably, relevant codes of the present extrapolating system and data to be processed are stored in a solid state disk, which, for example, is a DELL 1 TB SAS 3.5-inch server hard disk. The main part of the R-GCN encoder uses a graphic processing unit (GPU) to accelerate operation and it involves tenson matrix and convolution computation, which preferably is a Tesla M40. The main part of the emerging task processing unit uses a central processing unit (CPU) to acquire four layers of entity sets, which type is preferably Inter® Xeon® Gold 6132 @ 2.60 GHz. The main part of the temporal reasoning task prediction section uses a graphic processing (GPU) to perform task classification and multi-class task processing, and finally provides the prediction result with the highest level of probability, which type is preferably Tesla M40.

It is to be noted that the embodiments described above are exemplificative. Various modifications thereof are apparent to people skilled in the art with the enlightenment of the present disclosure, and all of these modifications form a part of the disclosure of the present invention as they all fall within the scope of the present invention. It is thus to be understood by people skilled in the art that the description and accompanying drawings provided by the present invention are only illustrative but not limiting to claims of the present application. The scope of the present invention shall be defined by the claims and their equivalents. The description of the present invention contains a number of inventive concepts, such as “preferably”, “according to a preferred embodiment” or “optionally” all indicate that the corresponding paragraph discloses an independent idea, and the applicant reserves the right to file a divisional application based on each of the inventive concepts. Throughout the disclosure, any feature following the term “preferably” is optional but not necessary, and the applicant of the present application reserves the rights to withdraw or delete any of the preferred features any time.

What is claimed is:

1. A knowledge-graph extrapolating method based on multi-layer perception, the method comprising:
using relational graph convolutional network encoders to learn embedding representations of entities, relations, and timestamps, and capturing dynamic evolution of a fact;
designing emerging task processing units to construct multiple layers of entity sets, and assigning a matching historical relevance degree to the entity sets at each of the multiple layers;
classifying prediction tasks into different classes of reasoning scenes, and connecting each of the classes of the reasoning scenes to the processing unit for the corresponding layer, so as to accomplish partition of the multiple layers of the historically relevant entity sets; and
using a multi-class task solving method to acquire predicted probability distributions of target entities, and taking the entity having a highest level of probability as a prediction answer, so as to accomplish extrapolation of a temporal knowledge graph,
wherein the prediction tasks are classified into different classes of reasoning scenes according to whether it contains any entity or any relation that has never appeared historically.

2. The knowledge-graph extrapolating method of claim 1, wherein the emerging task processing units search in the current fact for entities related to the prediction tasks and group the searched entities as entity sets of first, second, and third layers, and, by comparing all the entity sets of a data set, identify and group the entities that have never appeared into entity sets of a fourth layer, wherein at the first layer are the entity sets directly connected to relation predicates of the prediction tasks, at the second layer are the entity sets that can be reached by subject entities of the prediction tasks in one hop or two hops, at the third layer are the entity sets that can be reached through remaining paths in the current fact in multiple hops, and at the fourth layer are the entity sets that have never appeared historically.

3. The knowledge-graph extrapolating method of claim 2, wherein the historical relevance degrees assigned to the entity sets at the four layers are represented by scalars from inside to outside as α, β, γ and δ, wherein α>β>γ>δ, and α+β+γ+δ=1.

4. The knowledge-graph extrapolating method of claim 3, wherein the prediction tasks are at least classified into at least the four classes of reasoning scenes: Class 1, having neither never-appeared entities nor never-appeared relations, Class 2, having only never-appeared entities, Class 3, having only never-appeared relations, and Class 4, having both never-appeared entities and never-appeared relations.

5. The knowledge-graph extrapolating method of claim 4, further comprising processing the different prediction tasks at the different number of layers for the multi-layer path extrapolation and connecting each of the classes of the reasoning scenes to the processing unit for the corresponding layer, wherein the number of layers for the multi-layer path extrapolation corresponds to the entity sets at the multiple layers.

6. The knowledge-graph extrapolating method of claim 5, further comprising mapping each of the entities, relations, and timestamps data of the data set into a low-dimension dense vector space, initializing all pre-determined parameters through Xavier initialization, and then using Cross-Entropy Loss Function to minimize global loss thereby optimizing parameter learning.

7. The knowledge-graph extrapolating method of claim 6, wherein a ω-layer relational graph convolutional network encoder is used for representation learning to converge and extract features of the different relations, wherein the ω-layer relational graph convolutional network encoder is represented as:
$${h}_{s , {t}_{T}}^{( l + 1 )} = σ ( {\sum }_{( r , o ) \vert ( s , r , o , {t}_{T} ) ∈ {T}_{}} \frac{1}{N} {W}_{r}^{( l )} {h}_{o , {t}_{T}}^{( l )} + {W}_{loop}^{( l )} {h}_{s , {t}_{T}}^{( l )} ) ,$$
where h_{o,t}_{_{T}}^{(l)} and h_{s,t}_{_{T}}^{(l)} are embeddings of the entities s and o in a graph snapshot [symbol] _{T} at the l^{th} layer with a timestamp t_{T}, respectively, and Wᵣ^{(l)} and Wₗₒₒₚ^{(l)} are weight matrixes for converging the features from the different relations and a self-loop matrix for the l^{th} layer.

8. The knowledge-graph extrapolating method of claim 7, wherein the multi-class task solving method uses a multilayer perceptron and a SoftMax logistic regression model to convert the prediction tasks into entity multi-class tasks, wherein each of the classes corresponds to the level of probability of one of the target entities, so that the entity having the highest level of probability is taken as the prediction answer.

9. The knowledge-graph extrapolating method of claim 8, wherein a final prediction Oₜ_{_{q}} is the entity having a highest level of combined probability, defined as:
oₜ_{_{q}}=argmax_{o∈ε}p(o|s,r,t_{q}).

10. The knowledge-graph extrapolating method of claim 9, wherein in order to close the loop of the tested training, in the training process, the function Cross-Entropy Loss is used for updating of the tensors and the parameters, so as to appropriately adjust the prediction result.

11. A knowledge-graph extrapolating system based on multi-layer perception, the system comprising at least one processor configured to:
use relational graph convolutional network encoders to learn embedding representations of entities, relations and timestamps, and capture dynamic evolution of a fact;
design emerging task processing units to construct multiple layers of entity sets, and assign a matching historical relevance degree to the entity sets at each of the multiple layers;
classify prediction tasks into different classes of reasoning scenes, and connecting each of the classes of the reasoning scenes to the processing unit for the corresponding layer, so as to accomplish partition of the multiple layers of the historically relevant entity sets; and
use a multi-class task solving method to acquire predicted probability distributions of target entities, and take the entity having a highest level of probability as a prediction answer, so as to accomplish extrapolation of a temporal knowledge graph,
wherein the prediction tasks are classified into different classes of reasoning scenes according to whether it contains any entity or any relation that has never appeared historically.

12. The knowledge-graph extrapolating system of claim 11, wherein the emerging task processing units search in the current fact for entities related to the prediction tasks and group the searched entities as entity sets of first, second, and third layers, and, by comparing all the entity sets of a data set, identify and group the entities that have never appeared into entity sets of a fourth layer, wherein at the first layer are the entity sets directly connected to relation predicates of the prediction tasks, at the second layer are the entity sets that can be reached by subject entities of the prediction tasks in one hop or two hops, at the third layer are the entity sets that can be reached through remaining paths in the current fact in multiple hops, and at the fourth layer are the entity sets that have never appeared historically.

13. The knowledge-graph extrapolating system of claim 12, wherein the historical relevance degrees assigned to the entity sets at the four layers are represented by scalars from inside to outside as α, β, γ and δ, wherein α>β>γ>δ, and α+β+γ+δ=1.

14. The knowledge-graph extrapolating system of claim 13, wherein the prediction tasks are at least classified into at least the four classes of reasoning scenes: Class 1, having neither never-appeared entities nor never-appeared relations, Class 2, having only never-appeared entities, Class 3, having only never-appeared relations, and Class 4, having both never-appeared entities and never-appeared relations.

15. The knowledge-graph extrapolating system of claim 14, wherein the system is further configured to process the different prediction tasks at the different number of layers for the multi-layer path extrapolation and connect each of the classes of the reasoning scenes to the processing unit for the corresponding layer, wherein the number of layers for the multi-layer path extrapolation corresponds to the entity sets at the multiple layers.

16. The knowledge-graph extrapolating system of claim 15, wherein the system is further configured to map each of the entities, relations, and timestamps data of the data set into a low-dimension dense vector space, initialize all pre-determined parameters through Xavier initialization, and then use Cross-Entropy Loss Function to minimize global loss thereby optimizing parameter learning.

17. The knowledge-graph extrapolating system of claim 16, wherein a ω-layer relational graph convolutional network encoder is used for representation learning to converge and extract features of the different relations, wherein the ω-layer relational graph convolutional network encoder is represented as:
$${h}_{s , {t}_{T}}^{( l + 1 )} = σ ( {\sum }_{( r , o ) \vert ( s , r , o , {t}_{T} ) ∈ {T}_{}} \frac{1}{N} {W}_{r}^{( l )} {h}_{o , {t}_{T}}^{( l )} + {W}_{loop}^{( l )} {h}_{s , {t}_{T}}^{( l )} ) ,$$
where h_{o,t}_{_{T}}^{(l)} and h_{s,t}_{_{T}}^{(l)} are embeddings of the entities s and o in a graph snapshot [symbol] _{T} at the l^{th} layer with a timestamp t_{T}, respectively, and Wᵣ^{(l)} and Wₗₒₒₚ^{(l)} are weight matrixes for converging the features from the different relations and a self-loop matrix for the l^{th} layer.

18. The knowledge-graph extrapolating system of claim 17, wherein the multi-class task solving method uses a multilayer perceptron and a SoftMax logistic regression model to convert the prediction tasks into entity multi-class tasks, wherein each of the classes corresponds to the level of probability of one of the target entities, so that the entity having the highest level of probability is taken as the prediction answer.

19. The knowledge-graph extrapolating system of claim 18, wherein a final prediction Oₜ_{_{q}} is the entity having a highest level of combined probability, defined as:
oₜ_{_{q}}=argmax_{o∈ε}p(o|s,r,t_{q}).

20. The knowledge-graph extrapolating system of claim 19, wherein in order to close the loop of the tested training, in the training process, the function Cross-Entropy Loss is used for updating of the tensors and the parameters, so as to appropriately adjust the prediction result.
